(19) United States
(12) Patent Application Publication
(10) Pub. No.: US 2018/0058378 A1
(43) Pub. Date: Mar. 1, 2018

(54) PRESSURIZATION DEVICE FOR A LIQUID-OXYGEN TANK OF A ROCKET ENGINE

(71) Applicant: ARIANEGROUP SAS, Paris (FR)

(72) Inventors: Gérard Roz, Pressagny L'orgueilleux (FR); Didier VUILLAMY, Quincampoix (FR)

(73) Assignee: ARIANEGROUP SAS, Paris (FR)

(21) Appl. No.: 15/550,208

(22) PCT Filed: Feb. 9, 2016
(86) PCT No.: PCT/FR2016/050287

§ 371 Date: Aug. 10, 2017

(30) Foreign Application Priority Data
Feb. 12, 2015 (FR) 1551155

(51) Int. Cl. F02K 9/50; F02K 9/46

(52) U.S. Cl. CPC F02K 9/50; F05D 2260/85; F05D 2260/231; F02K 9/46

(57) ABSTRACT

After filling a tank (18) with liquid oxygen (20) that is to be used to feed a rocket engine (10) with oxidizer, but prior to causing the engine (10) to operate, the tank is pressurized by injecting gaseous nitrogen (N) into the tank. While the engine (10) is in operation, liquid oxygen (20) is taken off, the taken-off oxygen is heated so as to obtain gaseous oxygen, and the gaseous oxygen is injected into the gas blanket (42) of the tank, with the pre-pressurization nitrogen forming a nitrogen buffer (40) between the liquid oxygen present in the gaseous oxygen tank injected into the gas blanket.

The present invention relates to a method of pressurizing a liquid oxygen tank for feeding a rocket engine with oxidizer.

In order to operate the engine, oxygen is a propellant that acts as an oxidizer, and another propellant that acts as fuel, such as hydrogen or methane, is also used for feeding to the engine from another tank.

The propellants are stored in the liquid state in tanks, and the tanks are maintained under pressure in order to ensure that the propellants flow in regular manner to the engine.

The present invention relates to pressurizing the liquid oxygen tank. In order to pressurize this tank, it is known to inject an inert gas such as helium into the tank, which gas is stored in gaseous or liquid form in a dedicated auxiliary tank. For this purpose, helium is injected in the gaseous form into the top portion of the tank in order to form a gas blanket therein. That technique is used during pre-pressurization of the tank, prior to starting the engine for liftoff. It can also be used in flight, which then requires an onboard auxiliary tank.

It is also known to pressurize the tank with gaseous oxygen. For this purpose, liquid oxygen is taken from the tank or downstream from the tank, e.g. from the engine or its feed pump, and the oxygen that is taken off is heated by appropriate means in order to be gasified, with the resulting gaseous oxygen then being injected into the top portion of the tank in order to feed its gas blanket. That technique is used in particular during a stage of flight since it avoids any need for a dedicated auxiliary tank on board.

By convention, in the present text, the term “pre-pressurization” is used for the initial stage of pressurizing the tank that is performed prior to starting the engine and liftoff, while the term “pressurization” is used for the stage of pressurizing and maintaining pressure in the tank while in flight and while the engine is operating.

The two above-mentioned techniques are often combined, with helium gas pre-pressurization being used prior to starting the engine and the rocket lifting off, and with gaseous oxygen pressurization being used in flight.

Thus, in flight, the tank contains liquid oxygen in its bottom portion and a gas blanket comprising both helium and gaseous oxygen. For example, the liquid oxygen is at a temperature of 90.5 K, while the gaseous helium and the gaseous oxygen that has been injected into the top portion of the tank are initially at temperatures of about 300 K. Even if the gaseous helium cools down on contact with the liquid oxygen so as to reach a temperature close to that of the liquid oxygen, its density remains less than the density of the gaseous oxygen used for pressurization. Thus, the gaseous helium tends to rise in the gas blanket towards the top of the tank so that the gaseous oxygen comes into contact with the liquid oxygen. Consequently, the gas/liquid interface is an interface between liquid oxygen and gaseous oxygen. The heat exchanges that take place at this interface have the effect of reducing the temperature of the gaseous oxygen, thereby increasing its density. As a result, the mass of gaseous oxygen in the blanket of the tank increases, thereby increasing the overall mass of the tank. Furthermore, these heat exchanges lead to heating of the liquid oxygen, and towards the end of propulsion, the liquid oxygen might reach a temperature that is unacceptable for the engine, and in particular for its feed pump.

In summary, using helium as pre-pressurization gas prior to operating the engine is advantageous insofar as gaseous helium is light in weight, but it does not make it possible to form a buffer at the gas/liquid interface that is effective against the pressurization gas that is used while the engine is in operation.

The invention seeks to overcome the above-mentioned drawbacks, or at least to attenuate them.

The invention relates to the situation in which, after the tank has been filled with liquid oxygen but before the engine is put into operation, an inert pre-pressurization gas is injected to form a gas blanket in the tank. According to the invention, the inert gas is nitrogen.

Nitrogen is a gas that is chemically inert relative to oxygen, i.e. when it comes into contact with oxygen there is no chemical reaction. Furthermore, even though the nitrogen that cools down on coming into contact with the liquid oxygen stabilizes at a temperature that is higher than that of liquid oxygen (e.g. about 130 K), for a partial pressure that is high relative to the partial pressure of the oxygen, its density remains greater than the density of the gaseous oxygen, regardless of whether the gaseous oxygen is at its injection temperature (e.g. about 300 K) or at a stabilized temperature in the gas blanket (e.g. about 130 K).

Thus, the nitrogen used for pre-pressurizing the tank forms a buffer at the surface of the liquid oxygen, and as explained below, the buffer acts to separate the liquid oxygen from the gas used for pressurizing the tank during a stage in which the engine is in operation, even when the gas is gaseous oxygen.

Optionally, a single-phase layer of gaseous nitrogen is formed at the surface of the liquid oxygen.

Optionally, a layer of liquid nitrogen is formed at the surface of the liquid oxygen by causing the partial pressure of the nitrogen in the gas blanket to be greater than its saturated vapor pressure.

Under such circumstances, the nitrogen buffer formed at the surface of the liquid oxygen is a two-phase buffer, since it comprises a layer of liquid nitrogen in contact with the liquid oxygen, and above that layer, a layer of gaseous nitrogen that itself comes into contact with the gas used for pressurization while the engine is in operation.

In particular, the partial pressure of the nitrogen is caused to be greater than its saturated vapor pressure by acting on the total pre-pressurization pressure of the tank.

It is thus possible to create a layer of liquid nitrogen at the surface of the liquid oxygen present in the tank and to manage the thickness of this layer.

For example, the pre-pressurization gaseous nitrogen is injected at a temperature lying in the range 150 K to 350 K.

In an implementation, while the engine is in operation, liquid oxygen is taken off, the taken-off oxygen is heated so as to obtain gaseous oxygen, and the gaseous oxygen is injected into the gas blanket, the pre-pressurization nitrogen forming a nitrogen buffer between the liquid oxygen present in the tank and the gaseous oxygen injected into the gas blanket.

Thus, in order to pressurize the tank while the engine is in operation, oxygen present in the tank is used by being taken off in liquid form and then by gasifying it prior to injecting it. This makes it possible to avoid any need to use an auxiliary tank containing a pressurization gas. As mentioned above, in this method, the density of the gaseous nitrogen remains greater than that of the gaseous oxygen, such that the nitrogen buffer remains effective and avoids the gaseous oxygen present in the blanket of the tank from coming into contact with the liquid oxygen present in the bottom portion of the tank. This makes it possible to avoid large exchanges of heat between the gaseous oxygen present in the blanket of the tank and the liquid oxygen present in the bottom portion of the tank. Firstly, this makes it possible to avoid increasing the density and thus the mass of gaseous oxygen in the blanket of the tank, and secondly it makes it possible to avoid heating the liquid oxygen above limits that are acceptable for the engine, and in particular for its feed pump.

Optionally, the nitrogen buffer comprises a layer of liquid nitrogen in contact with the liquid oxygen, and gaseous nitrogen above the layer of liquid nitrogen.

Optionally, by injecting gaseous oxygen into the blanket of the tank, the partial pressure of nitrogen in the nitrogen buffer is reduced so as to vaporize the nitrogen of the liquid nitrogen layer. When doing this, it is preferable to ensure that the density of the saturated nitrogen vapor is greater than that of the gaseous oxygen so that the nitrogen continues to act as a buffer.

Thus, while the engine is in operation, the gas blanket is fed firstly with injected gaseous oxygen and secondly by vaporized nitrogen coming from the layer of liquid nitrogen. This vaporization of the liquid nitrogen contributes to maintaining a low temperature at the interface between the liquid oxygen and the nitrogen, e.g. a temperature of about 90.5 K, thus avoiding heating the liquid oxygen, which could be prejudicial to proper operation of the engine and/or its feed pump.

The invention can be well understood and its advantages appear better on reading the following detailed description of an embodiment given by way of non-limiting example.

The description refers to the accompanying drawings, in which:

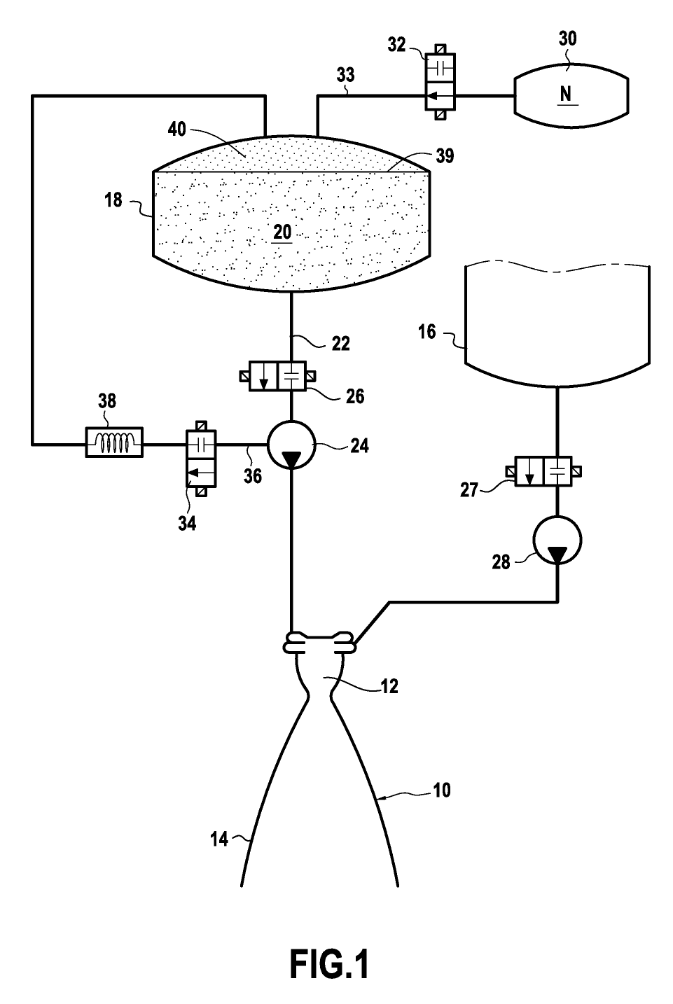

FIG. 1 is a diagram showing a portion of a propulsion assembly including a liquid oxygen tank, while the tank is being pre-pressurized;

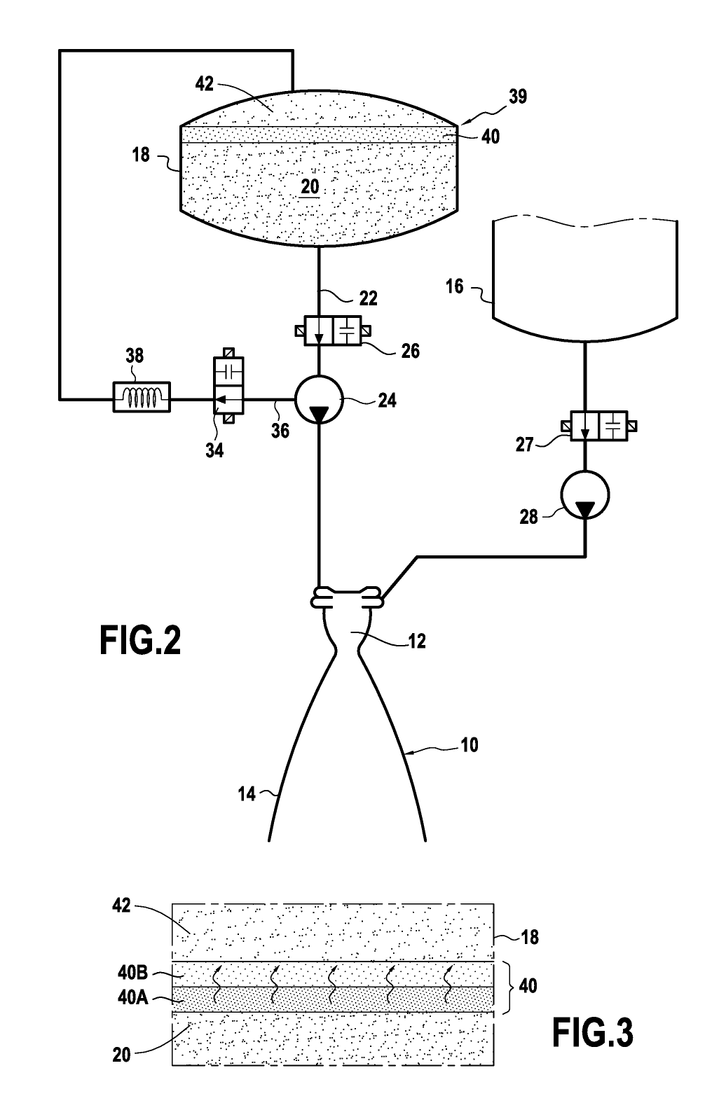

FIG. 2 shows the same portion of a propulsion assembly as FIG. 1, while the tank is being pressurized during a stage in which the engine is in operation; and

FIG. 3 is an enlarged fragmentary view showing the content of the oxygen tank during pressurization in the stage in which the engine is in operation, in a variant.

The propulsion assembly shown in part in FIGS. 1 and 2 comprises a rocket engine 10 having a combustion chamber 12 and a nozzle 14 including a diverging portion. The combustion chamber is fed with propellant from a first tank 16, shown in part, containing a first propellant that is used as fuel, in particular a reducing propellant such as hydrogen or methane, and the combustion chamber is also fed with oxygen from a second tank 18, where the oxygen constitutes a second propellant that acts as an oxidizer for combustion.

Attention is given in particular to the second tank 18 that contains liquid oxygen 20 situated in its bottom portion. The bottom of the tank is connected via a feed pipe 22 to a pump 24, in particular a turbopump, that is used for feeding the engine 10. An on/off valve 26 is arranged between the tank 18 and the pump 24. For feeding the engine 10 with the first propellant from the tank 16, the device shown in FIG. 1 also has a pump 28 and an on/off valve 27 in association with other necessary components (not shown).

The device shown in FIG. 1 also has an auxiliary tank 30 that, in principle, is not on board the rocket. That is why this tank is shown in FIG. 1 only, which shows the situation during the stage of pre-pressurizing the tank 1, before the rocket lifts off, and is not shown in FIG. 2, which shows the situation during a stage of pressurization while in flight. The tank 30 is connected to the top portion of the tank 18 via a feed pipe 33 and an on/off valve 32. The tank 30 contains nitrogen.

The device shown in FIGS. 1 and 2 also has means for taking liquid oxygen from the tank in order to heat the oxygen so as to take it to the gaseous state, and then injected into the top portion of the tank 18, into its gas blanket. Specifically, these means comprise a takeoff valve 34 arranged on a takeoff pipe 36 connected in parallel with the pump 24, and a heater 38 arranged in the pipe 36, which pipe is connected to the top portion of the tank 18. The heater 38 may be of any suitable type, for example it may comprise a resistance element or any other type of heat exchanger, e.g. a heater placed in the hot gas pipework of a gas generator of the type described in French patent application No. 3 009 587. Liquid oxygen is not necessarily taken from the pump. It could be taken from some other region of the feed pipe 22. It could also be taken via another pipe that is connected to the tank with the help of any appropriate means, such as a motor-driven pump or the equivalent.

In FIG. 1, the on/off valve 32 is in the open state such that the top of the tank is fed with gaseous nitrogen coming from the tank 30. In contrast, the takeoff valves 26, 27, and 34 are in the closed state such that the propellants coming from the tanks 16 and 18 do not feed the engine, which is not in operation, and oxygen is not taken from the outlet of the tank 18 for feeding the gas blanket. This is the situation that arises immediately before starting the engine and liftoff. The tank 18 has been filled with liquid oxygen 20 and this tank is put under pressure by creating a nitrogen gas blanket 40 above the liquid oxygen 20. The tank 18 is thus at a pressure of a few bars, e.g. 2 bars to 6 bars, depending on the architecture of the device.

FIG. 2 shows the same elements as FIG. 1, with the exception of the nitrogen feed pipe 33, the takeoff valve 32, and the tank 30, since these elements are not necessarily on board the rocket. FIG. 2 shows the situation during a stage in which the engine 10 is in operation. In this Figure, it can be seen that the combustion chamber 12 of the engine 10 is fed with propellants from the tanks 16 and 18, the takeoff valves 27 and 26 being open. Likewise, the takeoff valve 34 is open so that liquid oxygen is taken from the outlet of the tank 18, heated in the heater 38, and injected into the gas blanket of the tank 18. It can thus be seen that the tank 18 contains, going upwards: liquid oxygen 20, a layer of nitrogen 40 coming from the pre-pressurization, and a blanket of gaseous oxygen 42.

The nitrogen layer 40 forms a buffer between the liquid oxygen 20 and the gaseous oxygen 42. In this buffer, nitrogen may be present solely in the gaseous state, in which case the buffer is a single-phase gas buffer. Nevertheless, and as shown in FIG. 3, the nitrogen layer 40 may comprise a bottom layer 40A of liquid nitrogen in contact with the liquid oxygen 20, and a top layer 40B of gaseous nitrogen in contact with the gaseous oxygen 42.

Returning to FIG. 1, it can be seen that a few instants prior to liftoff, the liquid oxygen tank 18 is pre-pressurized using gaseous nitrogen. In this situation, heat exchanges take place in the tank 18, the gaseous nitrogen that is injected potentially being at a higher temperature than the liquid oxygen 20. For example, the gaseous nitrogen is injected at a temperature of about 300 K while the liquid oxygen is at a temperature of about 90.5 K. Thus, in contact with the liquid oxygen the pre-pressurization nitrogen cools down, but contact between the nitrogen and the dome of the tank, i.e. the top portion of the walls of the tank serves to heat the dome a little. The temperature of the gaseous nitrogen 40 may thus stabilize, e.g. at 130 K. Because of the heat supplied by the gaseous nitrogen, a small portion of liquid oxygen may become gas at the oxygen/nitrogen interface, such that the interface 39 may have a mixture of gaseous nitrogen and gaseous oxygen, while the top portion of the tank contains gaseous nitrogen 40. Insofar as nitrogen, even when cooled to a temperature of about 90.5 K at the interface 39, has density that is less than the density of oxygen, whether in the liquid or the gaseous state, the nitrogen remains above the liquid oxygen, and mixes only little with the gasified oxygen fraction. If the partial pressure of nitrogen in the gas blanket remains lower than the saturated vapor pressure of nitrogen at the temperature under consideration (which is 3.77 bars for nitrogen at 90.5 K), then the nitrogen remains gaseous. Under such conditions of temperature and pressure (the pressure lying for example in the range 2 bars to 6 bars), its density may reach a value greater than 15 kilograms per cubic meter (kg/m³).

In FIG. 2, the gaseous oxygen is injected into the gas blanket of the tank. Under the effect of the heater 38, the gaseous oxygen may reach a temperature of about 300 K, for example, and its density will be about 2.5 kg/m³ to 7.7 kg/m³ for conventional pressurization pressures, of about 2 bars to 6 bars. Thus, the density of the oxygen injected into the gas blanket is less than the density of the nitrogen in the layer 40, such that the gaseous oxygen 42 remains above the layer 40, which forms a buffer separating the liquid oxygen from the gaseous oxygen.

As mentioned above, this buffer may be a single-phase gas buffer, ignoring a small amount of liquid oxygen vaporizing that occurs strictly at the interface 39 between the nitrogen layer 40 and the liquid oxygen 20.

As mentioned above, the pre-pressurization pressure of the tank is of the order of 2 bars to 6 bars, for example. It may be decided to increase the partial pressure of nitrogen a little so that it reaches or exceeds its saturated vapor pressure, so that a fraction of the nitrogen liquefies. It is also possible to lower the temperature of the nitrogen injected into the tank, e.g. to the vicinity of 200 K or even 150 K, so as to increase its mass flow rate and favor its liquefaction. Nevertheless, the density of the liquid oxygen 20 is about 1.5 times greater than the density of liquid nitrogen, such that the layer of liquid nitrogen 40A shown in FIG. 3 remains on the surface of liquid oxygen. Above this layer of liquid nitrogen, the temperature increases progressively going up towards the top of the tank because of the heating of the gas blanket due in particular to injecting gaseous oxygen at a high temperature, e.g. about 300 K, so that a layer of gaseous nitrogen 40B remains over the layer of liquid nitrogen 40A. Thus, as shown in FIG. 3, the nitrogen buffer that forms between the liquid oxygen 20 and the gaseous oxygen injected by the pipe 36 is a two-phase buffer, comprising a liquid bottom layer 40A and a gaseous top layer 40B. The thickness of the liquid nitrogen layer 40A may be adjusted during the pre-pressurization stage. Specifically, starting from the moment when the partial pressure of the nitrogen reaches its saturated vapor pressure, it is possible to increase the duration or the flow rate of pre-pressurization so as to have the effect of increasing the partial pressure of the nitrogen, thereby favoring nitrogen liquefaction. The free surface of the liquid nitrogen behaves like the cold wall of a cryopump, thereby favoring liquefaction of gaseous nitrogen coming into contact therewith. When it is considered that a layer of liquid nitrogen of sufficient thickness has been obtained, it suffices to stop pre-pressurization. Furthermore, by lowering the temperature of the injected nitrogen during the pre-pressurization stage, e.g. to 200 K or even 150 K, it is possible to increase the quantity of liquefied nitrogen, but without that increasing the duration of the pre-pressurization stage.

While the engine is in operation, the tank 18 is pressurized by injecting gaseous oxygen, as mentioned above. In the temperature and pressure ranges that are conventionally used, the gaseous oxygen has density that is less than that of nitrogen, regardless of whether the nitrogen is the liquid nitrogen or the gaseous nitrogen in the layers 40A or 40B. Thus, the gaseous oxygen remains above the nitrogen buffer that has been created. As a result, the gaseous oxygen in the gas blanket remains well separated from the liquid oxygen 20. As the liquid oxygen 20 is consumed as the result of the engine operating, the gas volume in the gas blanket tends to increase, and insofar as the quantity of nitrogen present remains constant, the partial pressure of nitrogen decreases. Thus, the liquid nitrogen of the layer 40A tends to vaporize, thereby feeding the gaseous buffer of the layer 40B. This vaporization tends to avoid heating the liquid oxygen 20 present under the layer 40A and thus enables this oxygen to be maintained at a proper temperature for operation of the engine.

1. A method of pressurizing a liquid oxygen tank for feeding a rocket engine with oxidizer, in which method, after filling the tank with liquid oxygen but before causing the engine to operate, pre-pressurization gaseous nitrogen is injected into the tank in order to form a gas blanket, and a liquid nitrogen layer is formed at the surface of the liquid oxygen by causing the partial pressure of the nitrogen in the gas blanket to be greater than the saturated vapor pressure thereof.

2. A method according to claim 1, wherein the partial pressure of the nitrogen is caused to be greater than the saturated vapor pressure thereof by acting on a total pre-pressurization pressure of the tank.

3. A method according to claim 1, wherein the pre-pressurization gaseous nitrogen is injected at a temperature lying in the range 150 K to 350 K.

4. A method according to claim 1 wherein, while the engine is in operation, liquid oxygen is taken off, the taken-off oxygen is heated so as to obtain gaseous oxygen, and the gaseous oxygen is injected into the gas blanket, the pre-pressurization nitrogen forming a nitrogen buffer between the liquid oxygen present in the tank and the gaseous oxygen injected into the gas blanket.

5. A method according to claim 4, wherein the nitrogen buffer comprises a layer of liquid nitrogen in contact with the liquid oxygen, and gaseous nitrogen above the layer of liquid nitrogen.

6. A method according to claim 5, wherein, by injecting gaseous oxygen into the blanket of the tank, the partial pressure of nitrogen in the nitrogen buffer is reduced so as to vaporize the nitrogen of the liquid nitrogen layer.
